(19) United States
(12) Patent Application Publication
(10) Pub. No.: US 2026/0014585 A1
(43) Pub. Date: Jan. 15, 2026

(54) Dip Coating System for a Biological Sensor

(71) Applicant: Allez Health Inc., Carlsbad, CA (US)

(72) Inventor: Robert James Boock, Carlsbad, CA (US)

(73) Assignee: Allez Health Inc., Carlsbad, CA (US)

(21) Appl. No.: 19/262,885

(22) Filed: Jul. 8, 2025

Related U.S. Application Data
(60) Provisional application No. 63/669,843, filed on Jul. 11, 2024.

(51) Int. Cl. B05C 11/11; B05C 3/10

(52) U.S. Cl. CPC B05C 11/11; B05C 3/10

(57) ABSTRACT

Systems and methods for coating a working wire of a metabolic sensor include a chamber, a dipping station in the chamber, and a baffle configured to produce laminar flow over the dipping station. A controller is configured to activate the laminar flow during a dipping cycle at the dipping station, the dipping cycle including an insertion of the working wire into a dipping solution and a withdrawal of the working wire from the dipping solution. The baffle includes a first plate having first apertures of a first size and a second plate having second apertures of a second size, wherein the first plate is positioned over the second plate, with the second plate toward the dipping station.

### RELATED APPLICATIONS

This application claims priority to U.S. Provisional Patent Application No. 63/669,843, filed on Jul. 11, 2024, and entitled “Dip Coating System for a Biological Sensor”; the contents of which are incorporated by reference in full.

### BACKGROUND

Monitoring of glucose levels is critical for diabetes patients. Continuous glucose monitoring (CGM) sensors are a type of device in which glucose is measured from fluid sampled in an area just under the skin multiple times a day. CGM devices typically involve a small housing in which the electronics are located and which is adhered to the patient's skin to be worn for a period of time. A small needle within the device delivers the subcutaneous sensor, which is often electrochemical.

The CGM sensor is typically temporarily adhered to the patient's skin with an adhesive pad, and the CGM sensor couples to a small housing in which electronics are located. The CGM sensor typically has a disposable applicator device that uses a small introducer needle to deliver the CGM sensor subcutaneously for the patient. Once the CGM sensor is in place, the applicator is discarded, and the electronics housing is attached to the sensor. Although the electronics housing is reusable and may be used for extended periods, the CGM sensor and applicator need to be replaced often, usually every few days.

Electrochemical glucose sensors operate by using electrodes which typically detect an amperometric signal caused by oxidation of enzymes during conversion of glucose to gluconolactone. The amperometric signal can then be correlated to a glucose concentration. The electrode typically includes an electrically conductive substrate and one or more membrane layers that produce electrical current in response to the amount of glucose present in the patient's body. The construction of these layers affects the performance of the device, such as the output readings and sensitivity. Manufacturing processes for CGM sensors can affect the accuracy and repeatability of fabricating these layers.

### SUMMARY

In some aspects, the techniques described herein relate to a system for coating a working wire of a metabolic sensor, including: a chamber; a dipping station in the chamber; a baffle configured to produce laminar flow over the dipping station; and a controller configured to activate the laminar flow during a dipping cycle at the dipping station, the dipping cycle including an insertion of the working wire into a dipping solution and a withdrawal of the working wire from the dipping solution; wherein the baffle includes a first plate having first apertures of a first size and a second plate having second apertures of a second size; wherein the first plate is positioned over the second plate, with the second plate toward the dipping station.

In some aspects, the techniques described herein relate to a method of coating a working wire a metabolic sensor, the method including: providing a dipping station in a chamber; providing a baffle configured to produce laminar flow over the dipping station; and providing a controller configured to activate the laminar flow during a dipping cycle at the dipping station, the dipping cycle including an insertion of the working wire into a dipping solution and a withdrawal of the working wire from the dipping solution; wherein the baffle includes a first plate having first apertures of a first size and a second plate having second apertures of a second size; wherein the first plate is positioned over the second plate, with the second plate toward the dipping station.

In some aspects, the techniques described herein relate to a system for coating a working wire a metabolic sensor, including: a dipping container shaped as a vertical longitudinal container, having an entry port at a bottom end and an exit port at a top end, and configured to hold a dipping solution; a continuous feed wire source positioned to feed the working wire into the entry port; and an optical measurement tool configured to measure a diameter of the working wire after exiting the exit port.

### BRIEF DESCRIPTION OF THE DRAWINGS

FIG. 1 is a not-to-scale cross-sectional view of a working wire, in accordance with some aspects.

FIG. 2 is an isometric view of a wire-holding fixture and a container for a dipping solution, in accordance with some aspects.

FIGS. 3A-3B show a first side and second side of a wire-holding fixture, in accordance with some aspects.

FIGS. 4A-4B are schematic isometric views of systems for coating a material onto a working wire by dipping, in accordance with some aspects.

FIGS. 5A-5B are isometric schematic views of baffles configured to deliver laminar flow, in accordance with some aspects.

FIG. 6 is an exploded view of a baffle configured to produce laminar flow, in accordance with some aspects.

FIGS. 7A-7B are views a staging area for a dipping system, in accordance with some aspects.

FIGS. 8A-8B are perspective views of storage units for holding fixtures, in accordance with some aspects.

FIG. 9A shows an exploded isometric view of a dipping container for a dipping station, in accordance with some aspects.

FIGS. 9B-9C are views of dipping containers in which the dipping solution is recirculated, in accordance with some aspects.

FIGS. 10A-10B are schematics of systems for coating a working wire in a continuous manufacturing manner, in accordance with some aspects.

FIG. 11 is a flowchart of an example method of coating a working wire, in accordance with some aspects.

FIG. 12 is a flowchart of another method of coating a working wire, in accordance with some aspects.

FIG. 13 is a simplified schematic diagram of an example computer processor for use in the controllers of the methods and systems, in accordance with some aspects.

### DETAILED DESCRIPTION

Systems and processes for manufacturing working wires for a continuous biological sensor are described herein, that enable manufacturing scalability and improve accuracy and efficiency compared to known art. The continuous biological sensor may be, for example, a continuous glucose monitor, in which the working wire includes an enzyme layer to detect the level of glucose in a patient's blood. In other examples, the biological sensor can be a metabolic sensor for measuring other metabolic characteristics such as lactate, ketone or fatty acids. The sensor uses a working wire (i.e., an electrode for the sensor) that has a core and several concentrically formed membrane layers on the core.

The systems and processes described herein enable coating of membrane layers of a sensor for a biological sensor (such as a glucose sensor for a continuous glucose monitoring device or a lactate sensor for a continuous lactate monitoring device) in an efficient and accurate manner, using careful control and feedback of aspects such as air flow and environmental conditions. The membrane layers may be for a glucose limiting layer of a glucose sensor, for example, which may be formed by a dipping process to coat the membrane layers onto a working wire. The dipping solution for forming the glucose limiting layer may be a solvent-based solution. The systems and processes uniquely provide mass production of biological sensors in a repeatable manner and furthermore provide tracking of manufacturing parameters for each individual wire that is produced. This traceability is advantageous not only for keeping manufacturing records, but also enables precise calibration of each individual sensor by knowing the process conditions that were used for fabricating each particular sensor. As an example, the dip coating conditions for an individual sensor wire can be used to control the sensing layer thicknesses and consequently the sensitivity of the final sensor. This ability to predict the sensor's behavior over time can reduce or eliminate the need for local calibration by the patient using finger stick monitoring, as required with conventional CGM sensors.

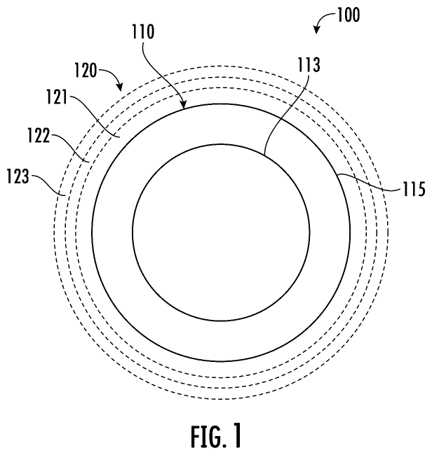

Referring to FIG. 1, a cross-sectional view of a working wire 100 is illustrated in accordance with some aspects. In this example, the working wire 100 is an elongated wire having a circular cross-section. It will be understood that other cross-sections may be used, such as square, rectangular, triangular, or other geometric shapes. Furthermore, the working wire 100 may take other forms, such as a plate or ribbon. The working wire 100 is used as a working electrode of a continuous biological sensor, such as a working electrode of a continuous glucose monitor.

In the illustrated example, the working wire 100 has a substrate 110 onto which biological membranes 120 may be disposed. In one example as illustrated, the biological membranes 120 include an interference membrane 121 (which may also be referred to as an interference layer) on the substrate 110, an enzyme membrane 122 (i.e., an enzyme layer) on the interference membrane 121, and a glucose limiting membrane 123 (i.e., a glucose limiting layer) on the enzyme membrane 122. In some aspects, a protective or outer coating may be optionally applied over the glucose limiting membrane 123. In cases where the working wire 100 is for a lactate sensor, glucose limiting membrane 123 may be instead configured as a lactate limiting layer. Although the working wire 100 is illustrated as having three biological membranes 120, it will be understood that the biological membranes 120 may be more or fewer in number.

The substrate 110 may be comprised of a core 113 with an outer layer 115. In the example of FIG. 1, the core 113 is an elongated wire that is dense, ductile, very hard, easily fabricated, highly conductive of heat and electricity, and may also be resistant to corrosion. Example materials for core 113 include tantalum (Ta), carbon (C), or cobalt-chromium (Co—Cr) alloys. The core 113 may have the outer layer 115, such as of platinum (Pt), deposited or applied using an electroplating process. It will be understood that other processes may be used for applying the outer layer 115 to the core 113. For a glucose monitor, the platinum outer layer facilitates a reaction where hydrogen peroxide reacts to produce water and hydrogen ions, and two electrons are generated. The electrons are drawn into the platinum by a bias voltage placed across the platinum wire and a reference electrode. In this way, the magnitude of the electrical current flowing in the platinum is intended to be related to the number of hydrogen peroxide reactions, which in turn is proportional to the number of oxidized glucose molecules. A measurement of the electrical current on the platinum wire can thereby be associated with a particular level of glucose in the patient's blood or interstitial fluid (ISF) (a biological fluid in the patient's body that contains diverse biomarkers and analytes and is similar to blood composition).

The core 113, outer layer 115, interference membrane 121, and enzyme membrane 122 form key aspects of the working wire 100. Other layers and/or membranes may be added depending upon the biological substance being tested for, and application-specific requirements. In some cases, the core 113 may have an inner core portion (not shown). For example, if the substrate (core 113) is made from tantalum, an inner core of titanium (Ti) or titanium alloy may be included to provide additional strength and straightness for the working wire 100.

One or more membranes (i.e., layers) may be provided over the enzyme membrane 122. For example, the glucose limiting membrane 123 may be layered on top of the enzyme membrane 122. This glucose limiting membrane 123 may limit the number of glucose molecules that can pass through the glucose limiting membrane 123 and into the enzyme membrane 122. The glucose limiting membrane 123 can be configured as described in U.S. U.S. Pat. No. 11,576,595, entitled “Enhanced Sensor for a Continuous Biological Monitor,” which is owned by the assignee of the present disclosure and is incorporated herein by reference as if set forth in its entirety. In some cases, the addition of the glucose limiting membrane 123 has been shown to enable better performance of the overall working wire 100.

The interference membrane 121 is applied over the outer layer 115 of the substrate 110. The interference membrane 121 may be disposed between the enzyme membrane 122 and the outer layer 115. This interference membrane 121 is constructed to fully wrap the outer layer 115, thereby protecting the outer layer 115 from, or mitigating, oxidation effects. The interference membrane 121 is also constructed to substantially restrict the passage of larger molecules, such as acetaminophen, to reduce contaminants that can reach the platinum of the outer layer 115 and skew results. Further, the interference membrane 121 may pass a controlled level of hydrogen peroxide (H₂O₂) from the enzyme membrane 122 to the platinum outer layer 115. Compositions for the interference membrane 121 and the enzyme membrane 122 may be as described in U.S. patent application Ser. No. 19/047,285, entitled “Continuous Biological Sensor with Enzyme Immobilization,” and U.S. patent application Ser. No. 17/449,380, entitled “In-Vivo Glucose Specific Sensor,” which are owned by the assignee of the present disclosure and incorporated herein by reference as if set forth in their entirety.

The interference membrane 121 may be electrodeposited onto the electrical conducting wire (i.e., substrate 110) in a very consistent and conformal way, thus reducing manufacturing costs as well as providing a more controllable and repeatable layer formation. The interference membrane 121 is formulated to be nonconducting of electrons but will pass negative ions at a preselected rate. Further, the interference membrane 121 may be formulated to be permselective (i.e., semipermeable) for particular molecules. In one example, the interference membrane 121 is formulated and deposited in a way to restrict the passage of larger molecules, which may act as contaminants to degrade the conducting layer (i.e., substrate 110), or that may interfere with the electrical detection and transmission processes.

In some examples, the glucose limiting membrane 123 (i.e., glucose limiting layer) is made from a hydrophilic bonding material, a hydrophobic bonding material, and a solvent as described in U.S. Pat. No. 11,576,595, entitled “Enhanced Sensor for a Continuous Biological Monitor” which is owned by the assignee of the present disclosure and is hereby incorporated by reference in its entirety. The glucose limiting membrane is constructed to provide a thin conformal layer of a physically cross-linked material that is easy to dispose of and that provides exceptional uniformity, glucose molecule control, and linearity results. In one specific example, the physically cross-linked material uses hydrogen-bonds. The hydrophilic bonding material, the hydrophobic bonding material, and the solvent are mixed together in a desired ratio, which results in a bonding gel. This bonding gel may then be applied over the enzyme layer on the working wire. The gel then cures to form strong and resilient hydrogen-bonded structures. The hydrophilic bonding material has a relatively high molecular weight, for example 1 to 5 million, or 1 to 3 million. As understood, the molecular weight of a polymer is the sum of the atomic weights of all the atoms in the molecule. Accordingly, the selected hydrophilic bonding material is typically a significantly large polymer. For example, polyvinyl alcohol, polyacrylic acid, or polyvinylpyrrolidone (PVP) may be used as a hydrophilic bonding material for the glucose limiting layer. The hydrophobic material is selected based on a desirable biocompatibility, as well as a ratio between hard and soft segments. The hydrophobic material may be selected that has an appropriate level of interaction with the solvent and hydrophilic materials, as well as having sufficient hardness to act effectively as a protective coating. In some examples, polyurethane may be used as a hydrophobic bond material, with the desired characteristics of both providing sufficient hardness, as well as desirable interaction with the hydrophilic bond material (e.g., PVP) and the selected solvent. Additionally, in some aspects, silicones may be used as the hydrophobic bonding material. The solvent is selected that is polar, binary, and sufficiently volatile for the curing needs. Trinary solvents can also be substituted. In one example, a mixture of a heavy organic compound with an alcohol may provide a desirable solvent for the glucose limiting layer. In a specific example, the heavy organic compound may be tetrahydrofuran (THF) or dimethylformamide (DMF), and the alcohol may be ethanol. As the curing occurs, the hydrophobic and hydrophilic bonding materials physically cross-link, and in particular, form hydrogen bonds. The resulting hydrogen bonded layer enables a highly desirable uniform and even passage of glucose molecules as compared to prior chemically bonded layers.

In some examples, the glucose limiting membrane 123 is made from a polyurethane with a molecular weight (MW) greater than 100,000 Daltons that is physically crosslinked with a water-soluble polymer having a molecular weight greater than 100,000 Daltons as described in U.S. patent application Ser. No. 17/449,380, entitled “In-Vivo Glucose Specific Sensor” which is owned by the assignee of the present disclosure and is hereby incorporated by reference in its entirety. The polyurethane may be, for example, a thermoplastic silicone polyether polyurethane or a thermoplastic silicone polycarbonate polyurethane. In some aspects, the water-soluble polymer of the glucose limiting layer may comprise polyacrylic acid, polyvinyl alcohol (PVA), polyvinylpyrrolidone (PVP) or poly(ethylene oxide) (PEO) or other water-soluble polymers (or combinations thereof) to physically crosslink with the polyurethane. In some aspects, the water-soluble polymer may be polyvinylpyrrolidone that is cross-linked with a thermoplastic silicone polyether polyurethane or a thermoplastic silicone polycarbonate polyurethane. This construction enables the glucose limiting layer to be highly effective at blocking or rejecting active electrochemical contaminants, such as acetaminophen, uric acid, and ascorbic acid. The blocking or rejecting may be due to bonding of the contaminants or due to charge-based interactions. For example, contaminants may become hydrogen bonded to PVP, thus being prevented from passing through the glucose limiting layer. In another example, PVA or polyacrylic acid may serve as charge repulsion materials, inhibiting certain contaminants from passing through.

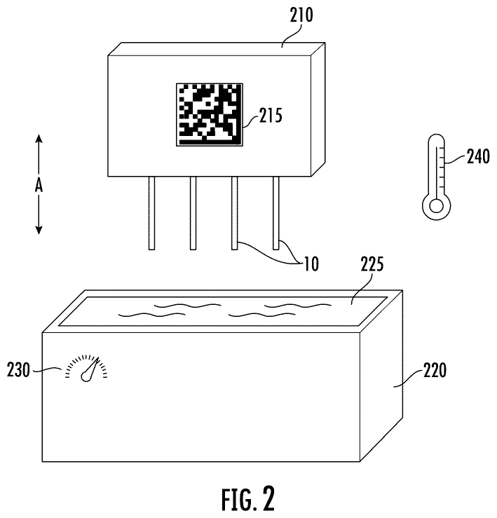

For any of the coatings (e.g., solvent-based coatings) used to form a membrane layer on the continuous biological sensor, a dipping process may be used. An example of a dipping station that may be utilized in the present disclosure is described in FIG. 2.

FIG. 2 is an isometric view of a wire-holding fixture 210 and a container 220 (e.g., tub, beaker, bowl) for holding a dipping solution, in accordance with some aspects. Multiple working wires 10 are mounted into the wire-holding fixture 210, where the working wires 10 may be uncoated or may have some but not all the membrane layers coated onto it. For example, working wires 10 may consist of only the substrate 110 (of FIG. 1), or may be in the process of dipping layers of the interference membrane 121, and enzyme membrane 122, or glucose limiting membrane 123 onto the substrate 110. The wire-holding fixture 210 is a holder, depicted as a block in this illustration, for transporting the working wires 10 through a coating process (dipping in this disclosure) during manufacturing. The wire-holding fixture 210 may also be referred to as a carrier or tray. The working wires 10 may be secured into the wire-holding fixture 210 by, for example, clamps, spring-loaded clips, set screws, adhesive fasteners, or other mechanisms. The wire-holding fixture 210 may include an identifier code 215 such as a scannable code (e.g., bar code or quick response “QR” code) that can be optically read by a scanner, camera, reader, optical device or imaging device (e.g., optical reader) for tracking the progress of the particular wire-holding fixture 210 during manufacturing. The identifier code 215 may be other types of identifying labels such as a radiofrequency identification (RFID) tag in which an RFID reader is used to read the RFID tag, or such as a near-field communication (NFC) element, to enable automated, contactless identification and data logging during manufacturing operations. Four working wires 10 are shown in this example, but the wire-holding fixture 210 may be configured to hold more or fewer working wires in other examples. The working wires 10 are mounted in a single row in this example, spaced apart and extending from an edge of the wire-holding fixture 210 so that each one can be measured individually from various angles. In other examples the wires may be arranged in other fashions such as in more than one row, aligned or staggered from each other, as long as sufficient space is provided between the working wires to enable each wire to be measured separately.

The container 220 holds a coating solution 225, such as a polymer or polymer mixture for the dip coating. The working wires 10 mounted on the wire-holding fixture 210 are submerged into the coating solution 225 to create a desired membrane on the wire. For example, the dipping process may be used to create enzyme membrane 122 or another membrane of the biological sensor (e.g., glucose sensor or a lactate sensor). Each membrane may require several dipping cycles (i.e., multiple coating iterations) to build up a desired thickness of the full membrane.

The container 220 may include one or more sensors 230 that monitor aspects of the coating solution such as viscosity or solution temperature. The system may also include environmental sensors 240 to monitor aspects of the ambient environment such as air temperature, relative humidity and airflow velocity. Aspects of the present disclosure beneficially utilize these environmental sensors to provide input to a controller to adjust dipping parameters during manufacturing, as described in U.S. Pat. No. 12,087,469, entitled “Coating a Working Wire for a Continuous Biological Sensor” which is owned by the assignee of the present disclosure and is hereby incorporated by reference in its entirety. In this manner, adjustments may be automatically made by a controller (described in later sections) to account for process variations that are extremely difficult to control manually. For example, changes in solution properties during the manufacturing process due to environmental factors can advantageously be compensated for in real-time. Lot-to-lot variations in solution viscosity or solids content can further affect how the environmental factors affect the solution. These impacts can also be accounted for by the present systems and methods.

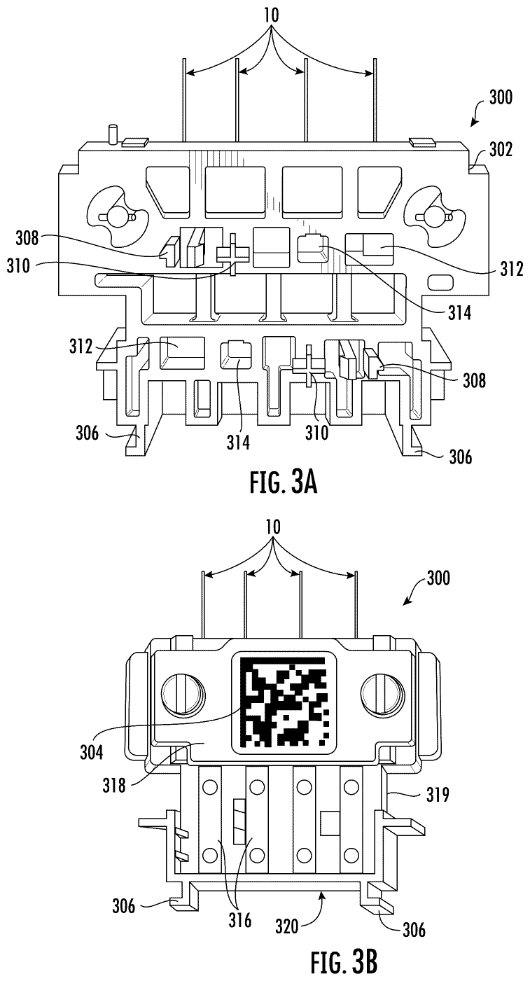

FIGS. 3A-3B show a first side and second side of a wire-holding fixture 300, in accordance with some aspects. In FIG. 3A, four working wires 10 are shown mounted into a body 302 of the wire-holding fixture 300. In other examples, the wire-holding fixture 300 may be configured to hold more or fewer working wires during manufacturing, such as 1 to 10, or 2 to 8, or 2 to 6, or other appropriate number or range. The wire-holding fixture 300 has L-shaped feet 306 to enable it to stand, be fixed in place, or be hung upside down as needed. Snapping tabs 308 are also included, extending outward from the face of the wire-holding fixture 300, to enable two wire-holding fixtures 300 to be snapped together (e.g., in pairs, back-to-back) and transported together during manufacturing. In this illustration, two sets of snapping tabs 308 and alignment posts 310 are positioned diagonally from each other on the wire-holding fixture 300. When two wire-holding fixtures 300 are placed with the same sides facing each other, a snapping tab 308 on one wire-holding fixture 300 fits into a tab hole 312 on the other wire-holding fixture 300 that it is being attached to (i.e., a mating fixture), and the alignment post 310 fits into an alignment hole 314 of the mating fixture. The diagonal positioning of the alignment posts 310 on the wire-holding fixtures 300 helps ensure that the wire-holding fixtures 300 are properly aligned in all axes, and the snapping tabs 308 lock the wire-holding fixtures 300 together. Being able to thus “gang” or attach wire-holding fixtures 300 together allows more than one wire-holding fixture 300 to be moved together at a time (e.g., by a robot), which increases manufacturing speed. Various features of the wire-holding fixture 300 such as wings, indentations, grooves, and the like, may be used as gripping features for a robot to grab. For example, recess 319 may be used as an area for robotic jaws to hold the wire-holding fixture 300. The features may be configured to provide proper alignment in the robot and when inserted into a dipping station (e.g., in x-y-z linear and rotational directions), since misalignment can affect the uniformity and/or concentricity of the coating on the working wire 10.

In FIG. 3B, the opposite face of the wire-holding fixture 300 of FIG. 3A is shown. An identifier code 304 (e.g., QR code or other identifier/scannable code) is included for tracking the wire-holding fixture 300 during manufacturing as described herein. In this example, the QR code is a sticker that is affixed to a plate 318 (e.g., metal) that is attached to the body 302 (e.g., plastic). Additionally, metal strips 316 are also shown. One metal strip 316 is present for and electrically connected to a corresponding working wire 10 in the wire-holding fixture 300. The metal strips 316 provide an electrical connection between the working wire 10 and a terminal point on a bottom side 320 of the wire-holding fixture 300 for various manufacturing process steps, such as electropolymerization and electrical testing (e.g., calibration). In other examples, the metal strips 316 may be configured as a wire, electrically conductive coating, or other electrical conduit between the working wire 10 and the terminal point on the bottom side 320 of the wire-holding fixture 300.

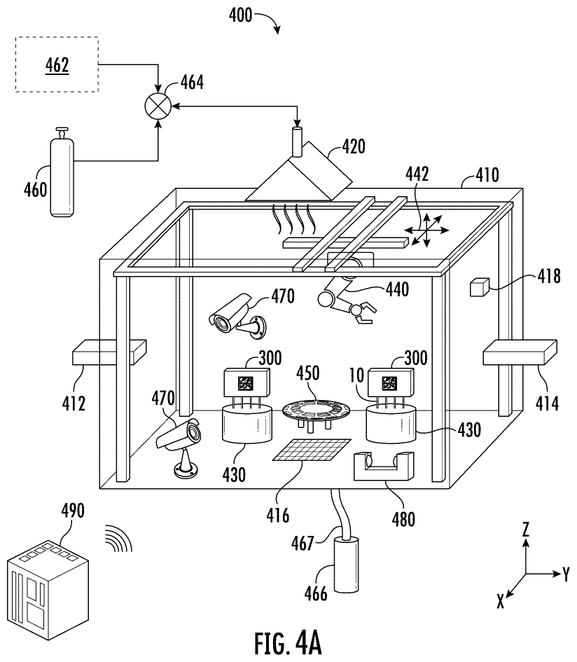

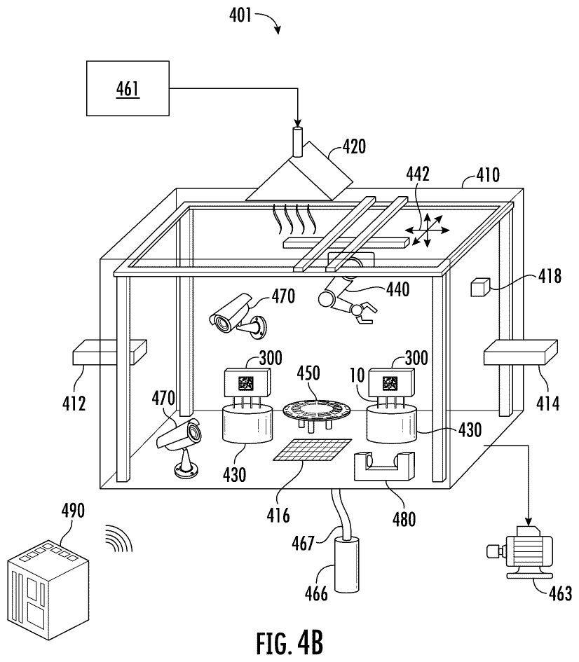

FIG. 4A is a schematic isometric view of a system 400 for coating a material onto a working wire by dipping, in accordance with some aspects. System 400 includes a chamber 410, a baffle 420, a dipping station 430, a robot 440, a drying rack 450, a gas source 460, a reader 470, and an optical measurement tool 480. The components are not drawn to scale. Chamber 410 serves as the primary enclosure or structure for the system 400, to provide an enclosed, controlled environment where working wires 10 can be coated. The working wires 10 being processed in the system 400 may also be referred to as work-in-progress (WIP) wires. Working wires 10 can be loaded onto wire-holding fixtures 300 and inserted into the chamber 410 through an input port 412 that is coupled to chamber 410. One or more dipping stations 430 are in the chamber 410 for performing the dipping operations. After a dipping cycle, the wire-holding fixtures 300 can be put in drying rack 450 to allow the coating to dry. In some cases, drying rack 450 may be a carousel with multiple slots that the wire-holding fixtures of FIGS. 3A-3B are placed into to allow working wires to dry. For a solvent-based coating solution, the solvent will evaporate, where fumes may be removed from the chamber 410 through a vent 416. The vent 416 is located at the bottom of the chamber 410 in this example. In other examples, the vent 416 may be elsewhere (e.g., on the side walls of the chamber), and/or the system may include a fume hood.

When all the dipping cycles for the wires have been completed, the wire-holding fixtures 300 (with working wires) can be removed from the chamber 410 through an output port 414 that is coupled to the chamber 410. The input port 412 and the output port 414 are configured to hold the wire-holding fixtures 300 and are on opposite sides of chamber 410 in this example. The input port 412 and output port 414 allow access to the chamber 410 without exposing the entire interior of the chamber to the ambient environment, thereby improving environmental control of the chamber. For example, the input port 412 and the output port 414 may be configured as an air lock, where a first door between the port and the outside environment opens separately from a second door between the port and the interior of the chamber. One or more desiccant tube 466 may be coupled to the chamber 410 (e.g., located underneath the chamber) to control the humidity level. Tubing 467 circulates air between the chamber 410 and the desiccant tube 466, where desiccant in the tube can remove moisture from the air.

Robot 440 is robotic mechanism, such as a 3-axis robot or 6-axis robot with a robotic manipulation arm, is in the chamber 410 for moving the wire-holding fixtures 300 to different locations in the chamber 410, such as between the input port 412, dipping stations 430, drying rack 450 and output port 414. In some examples, multiple robots 440 may be used in the chamber 410. The robot 440 may be positioned to load and unload a wire-holding fixture 300 from the dipping station 430. In some cases, the robot 440 can perform the dipping at the dipping station 430, while in other cases the robot 440 may load the wire-holding working fixture 300 into a separate mechanism of the dipping station 430 (e.g., a linear stage, lead screw, or other mechanism) that performs the dipping. The robot 440 is shown as a gantry robot in this example, enabling a wide range of motion in X, Y and Z directions (indicated by arrows 442) within the chamber. In other aspects, the robot 440 may be a stationary 6-axis robot located in the chamber at an appropriate position to move the wire-holding fixtures 300 within a designated range (e.g., from the input port 412 to a dipping station 430, between a dipping station 430 and the drying rack 450, and/or from the drying rack 450 to the output port 414).

To further automate flow for an overall manufacturing line, wire holding fixtures 300 may be delivered to the input port 412 of the dipping chamber (chamber 410) from a preceding manufacturing station by, for example, another robotic mechanism or a conveyor. Similarly, after completing the coating process in the dipping chamber, wire holding fixtures 300 may be delivered from the output port 414 of the dipping chamber to the next station in the manufacturing line by another robotic mechanism or another conveyor.

The reader 470, which may be an optical device or RFID reader as described above, is installed at one or more locations in the chamber 410. The reader 470 is positioned to scan an identifier code 304 (i.e., scannable code) on the wire-holding fixtures 300 to track the location of the fixtures by reading their QR codes (or other scannable code). For example, reader 470 may be positioned on a robotic arm of the robot 440, near the input port 412, near the output port 414, near the dipping station(s) 430, and/or near the drying rack 450. The reader 470 enables manufacturing data to be recorded for the working wires, such as what wire-holding fixture 300 is being dipped or cured, and what parameters were used for each individual fixture at each operation. In this illustration, the reader 470 is positioned near the input port 412 to track what wire-holding fixture 300 is being moved to the dipping process. Another reader 470 may be included near the dipping stations 430 to identify what wire-holding fixture 300 is at each dipping station 430 so that the system (e.g., a computer processor or controller 490 in communication with the dipping station 430) can provide instructions on what dipping parameters to use for that particular wire-holding fixture 300. The controller 490 may also inform the dipping station 430 if the wire-holding fixture 300 has completed sufficient dipping cycles, if a desired target total thickness has been reached.

Air circulation in the chamber 410 is important for maintaining tight control of air flow rates, temperature and relative humidity to ensure proper dipping. In this example of FIG. 4A, a gas source 460 is coupled to the chamber 410 through a baffle 420 that is configured to produce laminar flow (e.g., flow less than 90 feet/minute). The baffle 420 is coupled to the ceiling of the chamber 410 in this example so that air drifts downward, where the baffle 420 may be configured to produce a linear pattern of airflow in some examples. A laminar flow may be desirable so that air currents do not affect the coating thicknesses or uniformity of coating formed on the working wires 10. Baffle 420 may be sized to deliver air flow through a portion of chamber 410 or may be sized to span most or all of the ceiling of the chamber 410. In some cases, multiple baffles 420 may be coupled to the chamber 410, such as being positioned above each dipping station 430. The air delivered from the baffle 420 may be a mixture of ambient air 462 (having an ambient temperature and relative humidity) and a gas from a gas source 460 (e.g., with a predetermined relative humidity).

A mixing valve 464 may be positioned between the gas source and the baffle in this example, where the mixing valve 464 is configured to mix ambient air 462 and the gas from the gas source 460. The gas source 460 may contain, for example, dry nitrogen. The system 400 uses feedback from one or more environmental sensors 418 in the chamber 410 which monitor temperature and relative humidity. This feedback may be used by the controller 490 to adjust the mixing valve 464, determining the appropriate ratio of ambient air 462 and gas from the gas source 460 needed to achieve the desired environmental conditions inside the chamber 410. The ambient air 462 may be monitored so that the system 400 can determine the temperature and relative humidity of the ambient air 462 (e.g., air in a clean room where the chamber is located), allowing the controller 490 to adjust the mixture of ambient air 462 and gas from the gas source 460 accordingly. As an example, if the interior of the chamber 410 is too humid, a higher amount of dry nitrogen from gas source 460 may be supplied relative to the ambient air 462. The target relative humidity in the dipping chamber (chamber 410) may be, for example, between 5% to 30%, such as 15% to 20%. The relative humidity in the chamber 410 may be maintained within, for example, 1% of a target value (e.g., +1%). The arrangement shown in FIG. 4A provides continuous replenishment air in the chamber 410 that can be accurately adjusted and controlled.

An optical measurement tool 480 may be included in the chamber 410, where the optical measurement tool 480 is configured to measure a diameter of the working wire. The optical measurement tool 480 can provide feedback to a dipping station 430, via the controller 490 that uses a dipping algorithm to inform the system 400 of what dipping parameters to use for dipping the next layer on the working wire 10, or to inform the system 400 whether the desired membrane thickness has been achieved on the working wire 10. For example, the diameter of the working wire can be measured prior to dipping the working wire 10, to check the coating thickness resulting from the previously applied layer (e.g., after curing).

The in-line optical measurement tool 480 serves as an automated measurement system during the manufacturing process, where the diameter of each work-in-progress wire is measured to derive a coating thickness that has accumulated from the last dipping cycle. The optical measurement tool 480 may be, for example, an optical micrometer that utilizes a laser beam to measure dimensions in a non-contact manner. The laser micrometer detects the size of the WIP wire by measuring the shadow of the object that is within the path of the laser beam. The optical measurement tool 480 may be mounted on a stage that has both linear and rotational actuators, which enables the optical measurement tool 480 to be moved so that it can measure the WIP wires on the wire-holding fixture 300 from various angles and at various points along the length of the WIP wires.

In another aspect, a robotic arm of a robot 440 may be utilized to move the wire-holding fixture 300 while the WIP wires are being scanned by the optical measurement tool 480. In either case (whether the optical measurement tool 480 moves or the robot 440 moves the WIP wires), each WIP wire in the wire-holding fixture 300 may have its thickness measured along its entire length and at different angles around its entire circumference. In this way, thickness is defined for every WIP wire at each dip for both length and angular rotation. Measurements can be made at more than one location along a length of the WIP wire, and the wire-holding fixture 300 can be rotated around a longitudinal axis of the WIP wire so that the diameters are measured again along their length from a different orientation. In an example, each WIP wire can be measured at 10 to 40 points along its length, and from three different angles at each point. When the WIP wires have been measured as achieving the desired total coated membrane thickness, within an acceptable target window, the wire-holding fixture 300 unloaded, such as being placed in the output port 414.

As described in U.S. Pat. No. 12,087,469, the present apparatuses and methods adjust dipping parameters based on the measured thicknesses and on other factors that are monitored during dipping such as the temperature or viscosity of the coating solution. In some aspects, environmental factors can also be analyzed along with the coated wire measurements to adjust dipping parameters. In further aspects, coating solutions of different viscosities can be provided for the dipping process (e.g., at different dipping stations 430), and the system 400 can choose which viscosity to use based on the measurements. The systems and methods may optimize the manufacturing process, such as by reducing the number of dips required to achieve a desired coating thickness within a target window.

In one example, for the initial dip for the fixture, the robot 440 may perform the dip according to a wire plan, as instructed by controller 490. For subsequent dips in a sequence of multiple dips for the fixture, the robot 440 will perform the dip according to the wire plan along with applying adjustments made by the controller 490. Thicknesses of the coating layers are measured as an in-line process by optical measurement tool 480. That is, as the working wires progress through the dipping process, dipping parameters are adjusted as needed to achieve the required thicknesses within a target window of a thickness setpoint and/or within a predefined number of dips. For example, a total thickness of a glucose limiting membrane may be desired to be 4 microns to 25 microns, such as 6 microns to 19 microns, or 17 microns to 18 microns, where multiple coating layers are applied to form the total thickness. A total thickness of a lactate limiting membrane may be desired to be 4 microns to 20 microns, such as 10 microns to 15 microns, such as 11 to 13 microns, where multiple coating layers are applied to form the total thickness. A target window for a desired setpoint thickness may be, for example, +1 to +3 microns, such as +2 microns, +1 micron, or +0.5 microns of the setpoint thickness.

Following the measurement of thickness by the optical measurement tool 480, an algorithm compares that measurement (e.g., per an aggregate criteria such as an average or a median) to a thickness setpoint and determines the difference. If the total thickness of the working wire is within an acceptable range of the target dimension, the process is completed. If the target thickness has not been achieved, the algorithm then decides whether to alter one or more dipping parameters. The algorithm may alter the withdrawal speed of the working wire from the dipping (coating) solution based upon the remaining thickness that needs to be achieved and based upon a viscosity of the coating solution. Since viscosity can change during the process due to solvent evaporation, an in-line viscometer can be used to measure the viscosity, or a fixed time versus solvent loss relationship may be used to estimate the new viscosity. For example, the algorithm may optionally project a new viscosity of the solution according to an amount of time that has elapsed since the initial viscosity was input. The new viscosity may account for environmental conditions (e.g., from environmental sensors 240 or 418 of FIG. 2 or 4A, respectively). In this manner, the algorithm can shift the withdrawal vs. thickness curves used based upon viscosity.

The algorithm chooses a withdrawal speed utilizing a series of withdrawal speeds versus thickness curves that are created for ranges of potential viscosities. The range of viscosities may represent changing values of the viscosity of the coating solution over time, and/or may represent separate tubs of coating solutions with different viscosities that are available for the dipping process. The algorithm can use other forms of correlations rather than a correlation curve, such as a mathematical equation or a data table.

Aspects of the present disclosure include adjusting parameters based on aspects other than or in addition to withdrawal speed, viscosity and thickness as described herein. In some aspects, methods include dipping the plurality of wires using the adjusted parameters based on the thickness difference. In some aspects, calculating the adjusted parameters is further based on environmental factors, where the environmental factors comprise, for example, an airflow and a relative humidity of the airflow. In some aspects, calculating the adjusted parameters comprises referring to a set of correlations. Each correlation in the set of correlations may involve, for example, layer thickness as a function of withdrawal speed for a given viscosity of the coating solution. Some aspects include determining the viscosity of the coating solution and choosing a correlation in the set of correlations based on the viscosity. Determining the viscosity may include measuring the viscosity of the coating solution or estimating a viscosity of the coating solution based on a relationship of solvent loss over time for the coating solution.

FIG. 4B is a schematic isometric view of another system 401 for coating a material onto a working wire by dipping, in accordance with some aspects. FIG. 4B is similar to FIG. 4A, with some of the same components such as the chamber 410, baffle 420, dipping stations 430, robot 440, a drying rack 450, reader 470, and optical measurement tool 480 as described for FIG. 4A. However, the environmental air in the chamber in FIG. 4B is replenished periodically (e.g., on demand) rather than on a continuous basis as in FIG. 4A. In FIG. 4B, an external reservoir 461 is configured to supply a gas (e.g., nitrogen) that is preconditioned to a predetermined (target) relative humidity that is desired for the dipping chamber (chamber 410). The gas in the external reservoir 461 may also be maintained at a target temperature. In some examples, the air in the external reservoir 461 can be chilled, which can slow down the evaporation rate of moisture in the reservoir and therefore maintain the humidity level in the reservoir for a longer time. When the system 401 determines that the gas in the chamber 410 is trending out of or already is out of the desired range (e.g., humidity level, as measured by the environmental sensor 418), the dipping operations are paused, and a vacuum pump 463 evacuates the air from the chamber 410. The controlled air from the external reservoir 461 is then introduced into the chamber 410. When the chamber 410 has been adequately filled with the controlled air, dipping can be resumed. This on-demand approach may reduce the amount of time needed to condition the air in the chamber 410, such as to re-humidify the chamber to a desired level if the chamber is opened for maintenance.

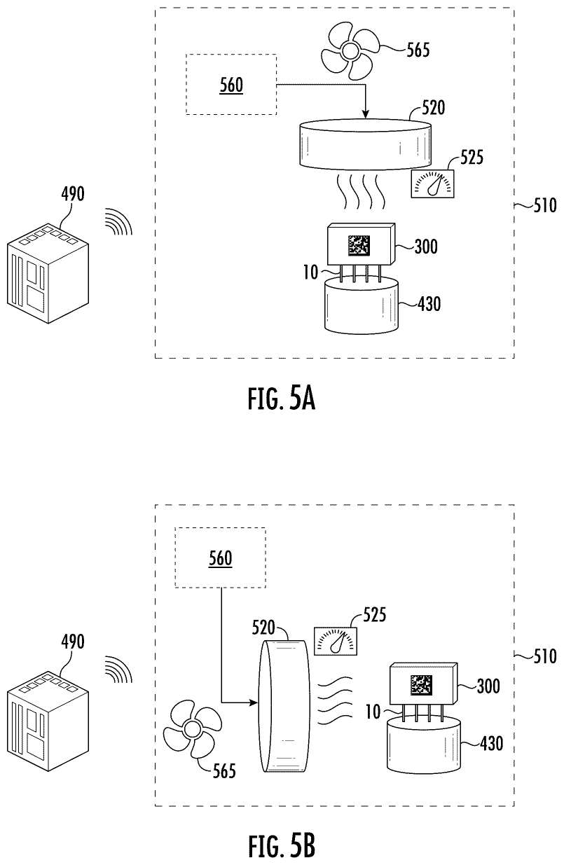

FIGS. 5A-5B are isometric schematic views of baffles configured to deliver laminar flow for individual dipping stations, in accordance with some aspects. The baffles of FIGS. 5A-5B may be used instead of the baffle 420 of system 400 or 401. The chamber 410 of FIGS. 4A and 4B is represented schematically as chamber 510. In FIGS. 5A-5B, a baffle 520 is positioned adjacent to the dipping station 430 and configured to direct the laminar flow directly over the dipping station. Having a dedicated baffle 520 for each dipping station 430 can advantageously help ensure laminar flow on the working wires 10 while they are being dipped during a dipping cycle (e.g., during insertion and/or withdrawal stages). For example, having a baffle delivering air locally at each dipping station can improve laminar flow at the dipping station compared to using a global baffle for the entire system, in situations where surrounding equipment in the chamber may cause interruptions in air flow to the dipping stations.

In FIG. 5A, a baffle 520 is positioned above dipping station 430 to direct laminar flow in a direction vertically downward relative to ground. In FIG. 5B, baffle 520 is positioned at the side of dipping station 430 to direct laminar flow in a direction horizontally relative to ground. For the horizontal configuration of FIG. 5B, in some cases the wire-holding fixture 300 may be rotated around a vertical axis while or after being removed from the dipping solution (e.g., by a robot), so that uniform air flow is experienced circumferentially by the working wires. A gas source 560 (e.g., supplying ambient air, dry gas from a gas source, or a mixture of ambient air and gas from a gas source) is coupled to baffle 520 to supply air flow via a fan 565. In some aspects, controller 490 may be in communication with gas source 560 and/or fan 565, where the controller 490 is configured to activate the laminar flow while the working wire is dipped at the dipping station. That is, controller 490 is configured to activate the laminar flow during a dipping cycle at the dipping station, the dipping cycling including an insertion of the working wire into a dipping solution and a withdrawal of the working wire from the dipping solution. The laminar flow may be active during an entire dipping cycle (e.g., insertion and withdrawal) or only during the withdrawal of the working wire from the dipping solution. Environmental conditions around the working wires during the withdrawal stage greatly affect the formed layer thicknesses and uniformity. Thus, activating laminar flow during the withdrawal stage can beneficially improve the quality of the working wires (e.g., uniform thickness, concentricity of the coating, reduced defects) compared to non-laminar flow. In some examples, the laminar flow may be turned on for about 2 seconds to about 30 seconds, or about 2 seconds to about 10 seconds, such as about 5 seconds while the working wires are being withdrawn (removed from) the dipping solution.

An air flow meter 525 may be positioned to measure an air flow rate of the laminar flow from the baffle 520. For example, the air flow meter 525 may be near an exit of the baffle 520 (e.g., separate from or mounted to the baffle 520) to monitor the air flow being delivered. It is desirable for the dip coating to solidify as quickly as possible after being dipped. The air flow meter 525 may be in communication with controller 490 to adjust the rate of air flow from baffle 520 (e.g., revolutions per minute of fan 565, and/or a flow rate from gas source 560) based on the dipping conditions for the working wires. For example, the controller 490 may instruct the fan 565 to produce higher air flow when thicker coating layers are being formed on working wires, and to produce lower air flow for thinner coating layers. In this manner, the adjustable air flow rates may result in more efficient manufacturing (e.g., reducing drying times) and/or higher quality working wires than using a constant air flow rate. For example, quality may be improved by avoiding air flow rates that are too low, allowing the coating to drip off the working wires, or air flow rates that are too high which may result in non-uniform coating around the circumference of the working wires.

Baffle 520 may have a diameter larger than the wire-holding fixture 300 or the dipping station 430 (e.g., a dipping container of the dipping station) to create a curtain of air (i.e., buffer zone) surrounding the working wires during the coating process. For example, the baffle 520 may be sized to be 25 mm to 75 mm, such as approximately 50 mm, beyond an edge of the wire-holding fixture 300 or a perimeter of the dipping station 430. In some cases, the baffle 520 of FIGS. 5A-5B may be fixed in position and seated adjacent to the dipping station 430 (e.g., laterally next to or above). In other cases, the baffle 520 may be coupled to the robot or other mechanism that moves the wire-holding fixture 300 during dipping, such that the baffle 520 moves with the wire-holding fixture 300 and thereby is adjacent to the dipping station 430 during dipping. The mechanism may be, for example, robot 440), a linear stage, or a lead screw.

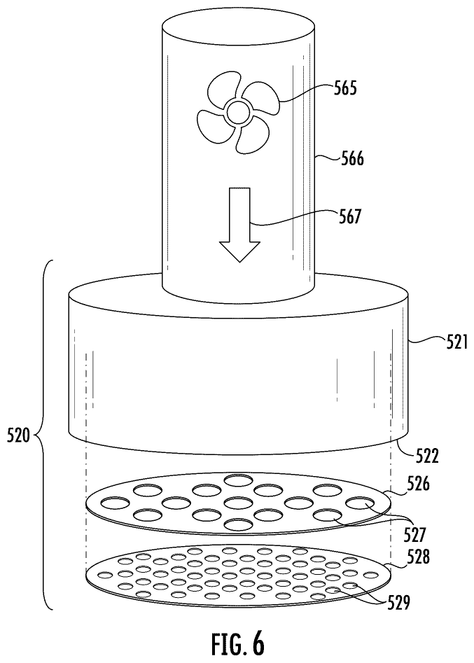

FIG. 6 is an exploded view of a configuration of baffle 520 to produce laminar flow, in accordance with some aspects. Baffle 520 includes a housing 521, a first plate 526, and a second plate 528. A duct 566 is coupled to housing 521 to deliver air flow 567 created by fan 565. The first plate 526 has first apertures 527 of a first size. The second plate 528 has second apertures 529 of a second size, where the first size may be larger than the second size. As one example, first apertures 527 may have a diameter or width of 5 mm to 7 mm, and second apertures 529 may have a diameter or width of 1 mm to 3 mm. The first plate 526 is positioned over the second plate 528 (e.g., stacked on each other with some space between them), with the second plate 528 toward the dipping station (i.e., nearest to exit end 522 of the housing 521). The apertures 527 and 529 are configured as circular or oval holes in this example but may be rectilinear or other shapes in other examples, such as a mesh or grid of square, rectangular, hexagonal openings. First plate 526 and second plate 528 may be made from a solid material with apertures 527 and 529 formed in them. In other cases, first plate 526 and second plate 528 may be a wire mesh, with the mesh size corresponding to the desired aperture size. The first apertures 527 may have the same or different shape as second apertures 529. Laminar flow is created from baffle 520 as a result of air flow from fan 565 passing through larger apertures (first apertures 527) and then smaller apertures (second apertures 529). In some examples, more than two plates may be utilized, such as three or more, where the apertures of the plates are sequentially smaller in the direction of the air flow 567. In some cases, first apertures 527 of first plate 526 may be offset from second apertures 529 of second plate 528 to assist in slowing down the air flow 567 to create the laminar flow. In some cases, the first plate 526 and second plate 528 may be aligned such that the apertures create a spiral flow path as the air travels through the sequence of plates.

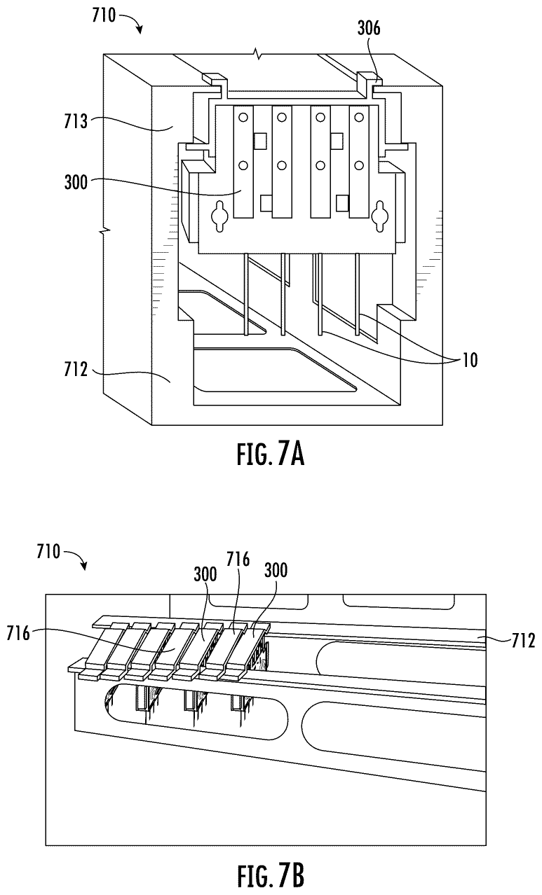

FIGS. 7A-7B are a front view and a side perspective view, respectively of a staging area 710 of the systems for dipping a working wire (e.g., systems 400, 401), in accordance with some aspects. Staging area 710 may be used, for example, in input port 412 or output port 414. Racks 712 are in the staging area 710, with wire-holding fixtures 300 in the racks 712. In some cases, two or more racks 712 may be present in the staging area 710, where some racks may be used for input (i.e., for wire-holding fixtures to be dipped) and the other racks may be used for output (i.e., for wire-holding fixtures after dipping has been completed). The wire-holding fixtures 300 are oriented upside down in FIGS. 7A-7B compared to FIGS. 3A-3B, such that the working wires 10 extend from the bottom edge of the wire-holding fixtures 300. The feet 306 of the wire-holding fixture in FIG. 7A rest along upper rails 713 of the rack 712 so that multiple wire-holding fixtures 300 can be slid onto and held in the rack 712 as shown in FIG. 7B. During manufacturing, multiple wire-holding fixtures 300 may be arranged on the rack 712. FIG. 7B is a side view of the rack 712, where spacers 716 are inserted between wire-holding fixtures 300 in this illustration. The spacers 716 are shaped similarly to the wire-holding fixtures 300 but are not configured to hold any working wires. In other words, the spacers 716 are dummy fixtures that serve to separate the working wires 10 of adjacent wire-holding fixtures 300 from each other, to help prevent damage to the working wires 10. A robot 440 can retrieve wire-holding fixtures 300 from the rack 712 to move the wire-holding fixtures 300 through the dip coating process.

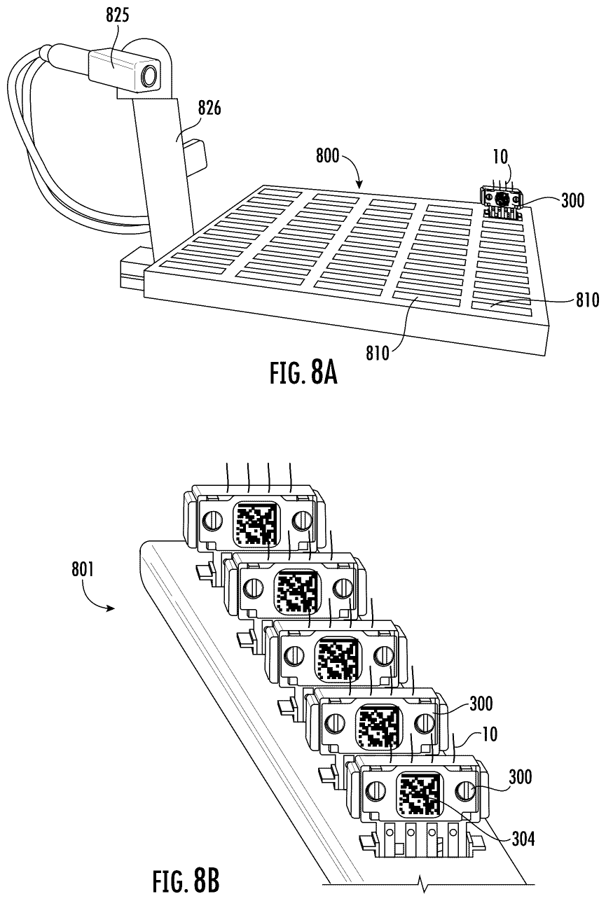

FIG. 8A shows a perspective view of a storage unit 800 for holding wire-holding fixtures 300, in accordance with some aspects. Storage unit 800 may be located near a dipping station 430 of the system (e.g., systems 400, 401), and/or at other locations in the system for temporarily holding wire-holding fixtures 300. The storage unit 800 has a plurality of slots 810 for wire-holding fixtures 300 to be placed into before or after dipping (e.g., while being moved between the staging area and the dipping area), or while waiting for other processing such as measuring diameters of working wires 10. The wire-holding fixtures 300 are positioned with the working wires 10 vertically upward, as also shown in the smaller storage unit 801 of FIG. 8B. The storage units 800 may be configured with various numbers of slots 810 depending on the quantity of working wires being processed during a manufacturing shift. The storage units 800 may be configured as a two-dimensional array as in FIG. 8A (e.g., five by eleven slots in this illustration), or a one-dimensional array as in FIG. 8B (e.g., one row of slots).

A reader 825, depicted in FIG. 8A as an optical device, may be included at or near (e.g., within the optical device's visual viewing range) the storage unit 800 to monitor which wire-holding fixtures 300 are being stored. The optical device (reader 825) can be a camera, laser scanner, or other device capable of reading a QR code or other scannable identifier on the wire-holding fixtures. In the example of FIG. 8A, the optical device (reader 825) is coupled to the storage unit 800 by an arm 826. When a robot (e.g., robot 440) picks up a wire-holding fixture 300 from the storage unit 800 or 801 or inserts a wire-holding fixture 300 into the storage unit, the robot can pass the wire-holding fixture 300 in front of the reader 825 to scan the identifier code 304 (FIG. 3B). Controller 490 can use the identifier code 304 to notify the system that the particular wire-holding fixture 300 is being processed, and the system can obtain manufacturing parameters (e.g., dipping parameters) and/or data (e.g., diameter measurements from previous dipping cycles) associated with the working wires 10 in that individual wire-holding fixture 300.

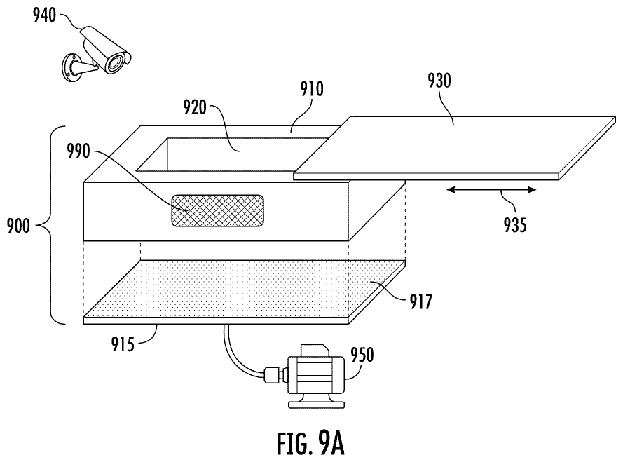

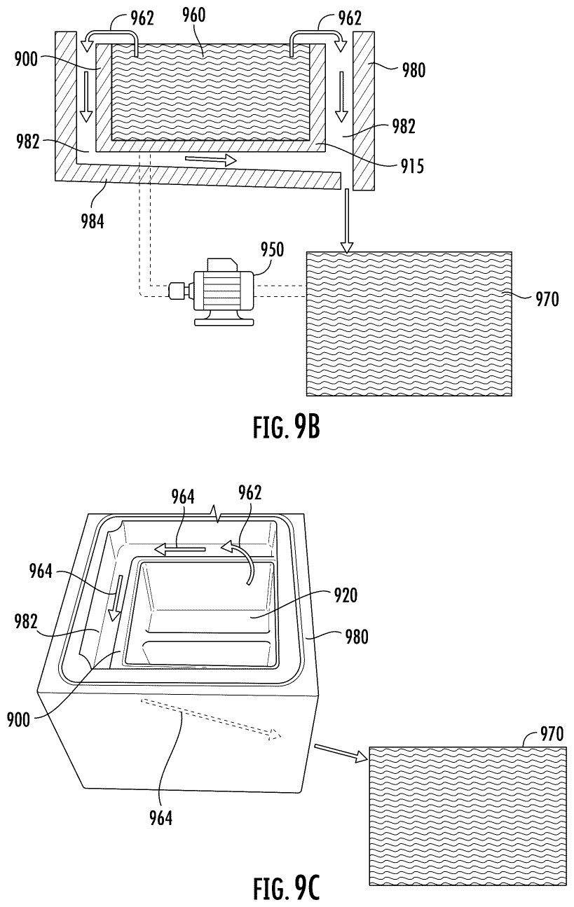

FIG. 9A shows an exploded isometric view of a dipping container 900 (i.e., tub, tank, pool) for a dipping station, in accordance with some aspects. The dipping container 900 has side walls 910 that form a cavity 920 where the dipping solution will be held. A lid 930 covers the cavity when the dipping station is not in use, to prevent components (e.g., solvents) in the dipping solution from evaporating and/or contaminants from falling into the dipping solution. In this example, the lid 930 slides across the top of the container 900 to open and close the container, as indicated by arrow 935. In other examples, the lid 930 may be hinged to flip upward from the container 900. In some examples, the lid 930 may be one piece or may be two pieces (e.g., two doors that slide away from each other or swing upward). Movement of the lid 930 may be automated, such as moved by a motor or linear actuator to keep the container 900 closed when not in use. For example, a controller (e.g., controller 490) may track the wire-holding fixtures 300 and instruct the dipping station to open the lid 930 of the dipping container 900 when a wire-holding fixture is ready for dipping, and then to close the dipping container when dipping is completed. In other words, the controller 490 may be configured to move the lid 930 between a closed position and an open position, the lid 930 being in the closed position when the dipping station is not in use.

Also shown in FIG. 9A is a fluid monitor 940 to track the fluid level of the dipping solution in the container 900. In this example, the fluid monitor 940 is a camera that can optically monitor the fluid level. For example, a starting line of the fluid level may be marked on the container 900, and the fluid monitor 940 can provide feedback to the robot (e.g., robot 440) or other mechanism that holds the wire-holding fixture 300 during dipping as the fluid level changes over time so that the robot can adjust how far to dip the working wires of the wire-holding fixture 300 into the container 900. Other fluid monitors that may be used instead of a camera are, for example, an ultrasonic level transmitter, a laser level transmitter, a float level transmitter, or other types of sensors. For any of these fluid monitors, the fluid monitor 940 can be in communication with the dipping mechanism, via a controller or computer processor (e.g., controller 490), to provide feedback on the location of the fluid surface.

In this example, a pump 950 is coupled to a bottom plate 915 of the dipping container 900, where the bottom plate has a plurality of holes 917 (apertures) across its surface (i.e., the bottom plate 915 may be a baffle or perforated plate). The pump 950 provides pressure and/or fluid through the perforated bottom plate 915 to move fluid to the top of the dipping solution surface to refresh the fluid. The perforated plate promotes laminar flow of the fluid and prevents a percentage of solid material from increasing at the surface of the fluid as solvent evaporates naturally.

In some aspects, the dipping container 900 may include a heat source 990 to keep the dipping solution at a desired temperature. For example, heat source 990 may comprise heating elements embedded in or mounted on the side walls 910 of the container 900.

FIG. 9B shows a cross-sectional side view of an example of the dipping container 900 of FIG. 9A, in which the dipping solution 960 is recirculated. As described for FIG. 9A, fluid circulation can help maintain a uniform distribution of polymers within the dipping solution 960 by preventing a gradient in solid materials through the depth of the solution (e.g., due to solvent evaporating at the surface). In FIG. 9B, the container 900 is similar to that of FIG. 9A, with a perforated bottom plate 915. The pump 950 provides fluid (dipping solution) from a reservoir 970 to the container 900 through the bottom plate 915, with a pressure and/or flow rate (e.g., laminar flow) that causes the fluid in the dipping container 900 to overflow (arrow 962). The overflowing fluid flows through a space or gap 982 between the container 900 and a surrounding recycling tank 980, to drain into the reservoir 970. Dipping solution from the reservoir 970 is then used to replenish the container 900 by being pumped back into the dipping container 900, creating an “infinity pool” effect. This effect refers to a continuous flow of liquid where the solution appears to seamlessly overflow or circulate without interruption, maintaining a consistent level in the container. The fluid monitor of FIG. 9A may not be needed in this example since the pump 950 creates an overflow condition in the dipping container 900. The lid 930 of FIG. 9A may be utilized but is not shown in FIG. 9B, for clarity.

In the example of FIG. 9B, the recycling tank 980 has an angled bottom surface 984 to aid in draining of the excess dipping solution into the reservoir 970. For example, the bottom surface 984 of the recycling tank 980 is slanted downward toward one end of the tank that connects to the reservoir 970. In another example shown in the top perspective view of FIG. 9C, the container 900 and recycling tank 980 are fabricated together as one piece. The container 900 is unfilled in this illustration, showing cavity 920 that is configured to hold dipping solution 960. In this example of FIG. 9C, the gap 982 between container 900 and recycling tank 980 may have an angled ramp around one or more sides of the container 900 that creates a downward path (arrows 964) for fluid to drain from an upper surface of the dipping container 900 and out to reservoir 970. In an alternative example, the top edge of the dipping container 900 may be slanted so that the overflowing fluid drains to one side, to be channeled into the recycling tank 980.

In the examples of FIGS. 9B-9C, the heat source 990 of FIG. 9A may be utilized. In addition, the reservoir 970 may be configured to have a larger volume than the dipping container 900 (i.e., volume of cavity 920). As one example, the ratio of volumes between the external reservoir 970 and the dipping container 900 may be greater than 2:1, such as 3:1 to 5:1 or more. Having a reservoir 970 with a volume that is larger than the dipping container 900 (i.e., volume of cavity 920) helps ensure that losing some of the fluid (dipping solution) in the dipping container 900 will not affect the uniformity of the solution.

In any of the dipping station configurations described above, the wire-holding fixtures may be held by a robot 440 with the working wires extending downward from the wire-holding fixture 300, to be dipped into the dipping container 900. The robot 440 may perform the dipping motion or may load the wire-holding fixture 300 into a separate mechanism that performs the dipping as described above. In some cases, more than one wire-holding fixture 300 may be dipped at a time, such as with two fixtures snapped together as described in relation to FIGS. 3A-3B.

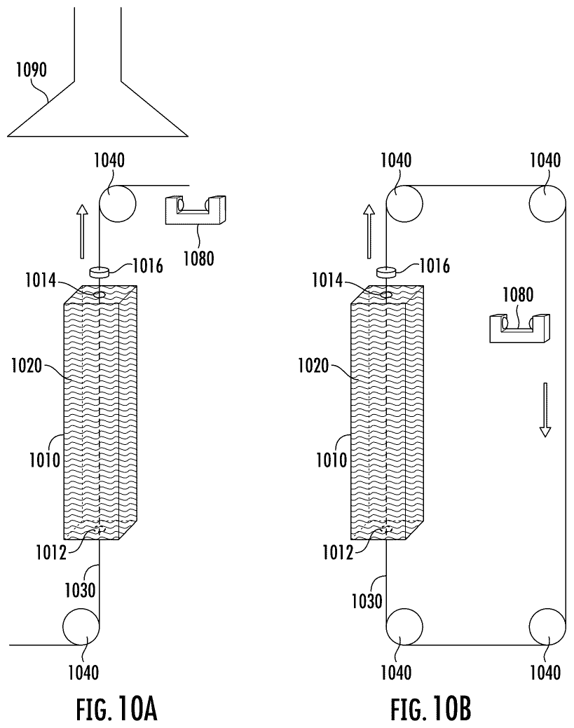

FIGS. 10A-10B are schematic diagrams of example coating systems in which a working wire for a biological sensor (e.g., a metabolic sensor, such as a glucose sensor or a lactate sensor) can be coated in a continuous manner, in accordance with some aspects. Continuous manufacturing may involve processing the working wire as a continuous length (e.g., fed from a spool) rather than by processing individual pieces of wire that are cut to discrete lengths. In FIG. 10A, the dipping container 1010 is a vertical chamber having a dipping solution 1020 inside. A working wire 1030 is fed from a wheel 1040 (e.g., spool, pulley) serving as a continuous feed wire source, into an entry port 1012 of the dipping container 1010, and traverses vertically upward through the length of the dipping container 1010. The entry port 1012 is sealed so that dipping solution 1020 does not leak out of the dipping container 1010. For example, the entry port 1012 may comprise one or more O-ring seals (e.g., two O-rings placed in series). The working wire 1030 then exits through an exit port 1014 which may also be sealed (e.g., with an O-ring) or may be an open aperture without a seal. Having the dipping solution 1020 contained inside a closed dipping container 1010 helps prevent the solvent (e.g., a volatile solvent) of the dipping solution from evaporating. After the working wire 1030 leaves the dipping container 1010, the working wire 1030 can optionally be pulled through a die 1016, where the size of the die (i.e., a hole in the die through which the working wire 1030 is pulled) can be used to remove excess coating while the coating is still wet, and/or to control the thickness and/or concentricity of the coating on the working wire 1030. The speed of the working wire 1030 through the dipping container 1010 can be controlled or adjusted according to diameter measurements (corresponding to coating thickness) taken by an optical measurement tool 1080 between dipping cycles. A fume hood 1090 may be present to remove solvent fumes from the working wire 1030 after it exits the dipping container 1010.

FIG. 10B shows the same dipping configuration as FIG. 10A but in a closed-loop manufacturing flow. In this example, a working wire 1030 is routed along a series of spools or wheels 1040 (e.g., pulleys) in a loop so that the working wire 1030 can return to be dipped another time, to deposit another layer of coating. The length of the path around the loop may be configured to allow sufficient time for the coating to dry between dips (e.g., for the solvent to flash off). In some cases, slack may be built into the path to allow more or less time before returning to be dipped, and/or to allow for variations in speed within the route. For example, the wheels 1040 may be spools that the wire is wound upon before proceeding onward, or additional wheels 1040 may be placed along the path with positions that are variable to create a longer or shorter path when needed. An optical measurement tool 1080 may be included along the path of the loop to measure the diameter of the coated working wire 1030 before the next dipping cycle, to adjust dipping parameter(s) (e.g., pulling/withdrawal speed through the dipping container 1010) accordingly.

The dipping stations of FIGS. 10A-10B may be enclosed in a chamber as described in FIGS. 4A-4B, where working wire 1030 may be fed through the input port 412 and the output port 414 from a preceding or to subsequent manufacturing stations. Alternatively, dipping within the chamber may be performed on an individual spool of wire, where the spool may be moved between manufacturing stations. The dipping stations of FIGS. 10A-10B may also include local baffles as described in FIGS. 5A-5B, positioned near the exit port 1014 where the working wire 1030 exits the dipping container 1010. In some aspects, the dipping stations of FIGS. 10A-10B may include a baffle configured to produce laminar flow over the exit port of the dipping container; and a controller configured to activate the laminar flow while the working wire is exiting the exit port; wherein the baffle comprises a first plate having first apertures of a first size and a second plate having second apertures of a second size; wherein the first plate is positioned over the second plate, with the second plate toward the dipping container. In some cases, the first size of the first apertures is larger than the second size of the second apertures.

In some aspects, a system (e.g., of FIGS. 10A-10B) for coating a working wire a metabolic sensor includes a dipping container shaped as a vertical longitudinal container, the dipping container having an entry port at a bottom end and an exit port at a top end, and configured to hold a dipping solution. The system also includes a continuous feed wire source positioned to feed the working wire into the entry port; and an optical measurement tool configured to measure a diameter of the working wire after exiting the exit port.

In some aspects, the system (e.g., of FIGS. 10A-10B) may include a baffle configured to produce laminar flow over the exit port of the dipping container; and a controller configured to activate the laminar flow while the working wire is exiting the exit port. The baffle may include a first plate having first apertures of a first size and a second plate having second apertures of a second size; wherein the first plate is positioned over the second plate, with the second plate toward the dipping container. In some cases, the first size of the first apertures is larger than the second size of the second apertures. In some cases, a die is between the optical measurement tool and the exit port, the die having a hole through which the working wire is passed. In some cases, the system includes a controller configured to control a speed of the working wire through the dipping container. In some cases, a plurality of pulleys positioned to form a closed-loop path for the working wire between the exit port and the entry port of the dipping container. In some cases, the continuous feed wire source is a spool.

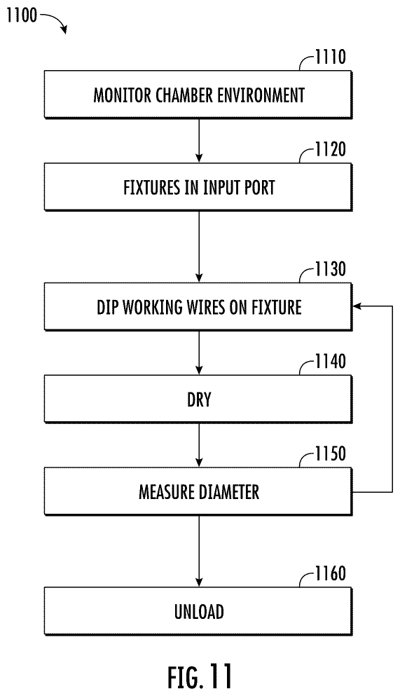

The flowchart of FIG. 11 is a flowchart of an example method 1100 of coating a working wire using the apparatuses described herein, in accordance with some aspects. The particular steps, order of steps, and combination of steps are shown for illustrative and explanatory purposes only. Other examples can implement different particular steps, orders of steps, and combinations of steps to achieve similar functions or results. In block 1110, the chamber environment is monitored. If the temperature and/or relative humidity in the chamber needs to be adjusted, gas can be supplied to the chamber in a continuous manner as described in FIG. 4A (e.g., with a mixture of ambient air and dry gas) or on demand as described in FIG. 4B (e.g., evacuating the chamber and pulling pre-conditioned gas from an external reservoir). In block 1120, wire-holding fixtures that have working wires loaded into them are stored in an input port of a dipping chamber. In other examples involving a continuous flow, the wires may be supplied to a dipping station by a spool.

In block 1130, a robot takes fixtures from the input port or a drying rack (if already dipped at least once) and moves them to a dipping station for dipping. An optical device such as a camera scans each fixture's QR code (or other identifier) and sends information to a computer processor to track the fixture's progress. For example, the computer processor or controller may record the time the fixture was moved and track location of the fixture. The parameters for that dipping (i.e., coating) cycle may also be recorded. The dipping may be, for example, a solvent-based solution to form a glucose limiting layer of a glucose sensor or a lactate limiting layer of a lactate sensor. A baffle may provide laminar flow to the dipping station while the dipping occurs. The baffle may be for the entire chamber or may be local to each dipping station, such as mounted on a robot performing the dipping.

In block 1140, the wires are allowed to dry, such as by using a robotic mechanism to place them on a drying rack. In block 1150, diameters of the coated working wires may be measured to determine if further dipping is needed and/or to adjust the dipping parameters to be used on the next dip. The dipping, curing (drying), and measuring may be repeated until the desired total membrane layer thickness is reached. In block 1160, after the desired coating thicknesses have been fabricated, the fixtures are unloaded and placed into the output port to be moved to the next manufacturing process station.

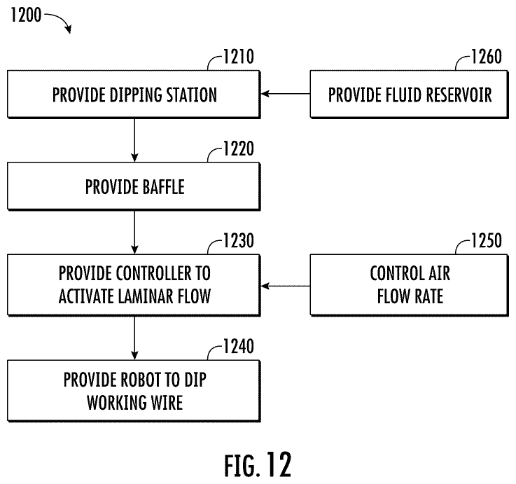

FIG. 12 is a flowchart of an example method 1200 of coating a working wire using the apparatuses described herein, in accordance with some aspects. The particular steps, order of steps, and combination of steps are shown for illustrative and explanatory purposes only. Other examples can implement different particular steps, orders of steps, and combinations of steps to achieve similar functions or results. Block 1210 involves providing a dipping station in a chamber. Block 1220 involves providing a baffle (e.g., baffles 420 or 520 of FIG. 4A, 4B, 5A or 5B) configured to produce laminar flow over the dipping station. Block 1230 involves providing a controller configured to activate the laminar flow while the working wire is dipped at the dipping station. The activation may be by turning on a gas source and/or a fan to deliver air flow to the baffle. The baffle comprises a first plate having first apertures of a first size and a second plate having second apertures of a second size, the first size being larger than the second size. The first plate and the second plate are stacked on each other, with the second plate toward the dipping station.

In some aspects, method 1200 may include block 1240 of providing a robot configured to move the wire-holding fixture (and thus working wires) into and out of a dipping solution at the dipping station. The baffle of block 1220 may be coupled to the robot. In some aspects, method 1200 may include block 1250 of controlling, by the controller, the laminar flow based on an air flow rate measured by an air flow meter. In some aspects, method 1200 may include block 1260 of providing a fluid reservoir in fluid communication with a plurality of holes in a bottom surface of a container at the dipping station (e.g., FIGS. 9A-9C), the container configured to hold a dipping solution.

Method 1200 may also include the steps of performing the dipping as described in FIG. 11. For example, method 1200 may include measuring, by an optical measurement tool in the chamber, a diameter of the working wire in a wire-holding fixture; moving, by a robot in the chamber, the wire-holding fixture between the optical measurement tool and the dipping station; and controlling, by the controller in communication with the optical measurement tool and the robot, a dipping parameter based on the diameter measured by the optical measurement tool.

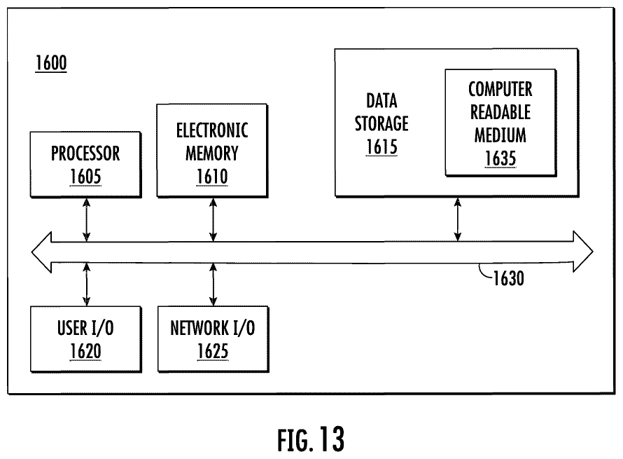

FIG. 13 is a simplified schematic diagram showing an example computer processor 1600 (representing any combination of one or more of the computers) which may be used to implement the controllers of the methods and systems, in accordance with some aspects. Other implementations may use other components and combinations of components. Other examples may use other components and combinations of components. The controller may be embodied in or include one or more computing devices, such as the example computer processor 1600, depending on the complexity and specific configuration of the system. For example, the computer processor 1600 may represent one or more physical computer devices or servers, such as web servers, rack-mounted computers, network storage devices, desktop computers, laptop/notebook computers, etc., depending on the complexity. In some aspects implemented at least partially in a cloud network potentially with data synchronized across multiple geolocations, the computer processor 1600 may be referred to as one or more cloud servers. In some aspects, the functions of the computer processor 1600 are enabled in a single computer device. In more complex implementations, some of the functions of the computing system are distributed across multiple computer devices, whether within a single server farm facility or multiple physical locations. In some aspects, the computer processor 1600 functions as a single virtual machine.

In this illustration, the computer processor 1600 generally includes at least one processor 1605, a main electronic memory 1610, a data storage 1615, a user input/output (I/O) 1620, and a network I/O 1625, among other components not shown for simplicity, connected or coupled together by a data communication subsystem 1630. A non-transitory computer readable medium 1635 includes instructions that, when executed by the processor 1605, cause the processor 1605 to perform operations including calculations and methods as described herein.

In accordance with the description herein, the various components of the system or method generally represent appropriate hardware and software components for providing the described resources and performing the described functions. The hardware generally includes any appropriate number and combination of computing devices, network communication devices, and peripheral components connected together, including various processors, computer memory (including transitory and non-transitory media), input/output devices, user interface devices, communication adapters, communication channels, etc. The software generally includes any appropriate number and combination of conventional and specially-developed software with computer-readable instructions stored by the computer memory in non-transitory computer-readable or machine-readable media and executed by the various processors to perform the functions described herein.

Any method (also referred to as a “process” or an “approach”) described or otherwise enabled by the disclosure herein may be implemented by hardware components (e.g., machines), software modules (e.g., stored in machine-readable media), or a combination thereof. By way of example, machines may include one or more computing device(s), processor(s), controller(s), integrated circuit(s), chip(s), system(s) on a chip, server(s), programmable logic device(s), field programmable gate array(s), electronic device(s), special purpose circuitry, and/or other suitable device(s) described herein or otherwise known in the art. One or more non-transitory machine-readable media embodying program instructions that, when executed by one or more machines, cause the one or more machines to perform or implement operations comprising the steps of any of the methods described herein are contemplated herein. As used herein, machine-readable media includes all forms of machine-readable media (e.g., one or more non-volatile or volatile storage media, removable or non-removable media, integrated circuit media, magnetic storage media, optical storage media, or any other storage media, including RAM, ROM, and EEPROM) that may be patented under the laws of the jurisdiction in which this application is filed, but does not include machine-readable media that cannot be patented under the laws of the jurisdiction in which this application is filed.

As described herein, the present systems and processes enable coating of a working wire of a biological sensor, such as a glucose sensor or a lactate sensor, to be performed in an automated fashion with high accuracy and trackability.

Example aspects of the present systems and methods are described in the clauses below

### Clauses

Clause 1. A system for coating a working wire of a metabolic sensor, comprising: a chamber; a dipping station in the chamber; a baffle configured to produce laminar flow over the dipping station; and a controller configured to activate the laminar flow during a dipping cycle at the dipping station, the dipping cycle including an insertion of the working wire into a dipping solution and a withdrawal of the working wire from the dipping solution. The baffle comprises a first plate having first apertures of a first size and a second plate having second apertures of a second size; and the first plate is positioned over the second plate, with the second plate toward the dipping station.

Clause 2. The system of clause 1, wherein the metabolic sensor is a continuous glucose monitor.

Clause 3. The system of any of clauses 1-2, wherein the baffle is coupled to a ceiling of the chamber.

Clause 4. The system of any of clauses 1-3, wherein the baffle is positioned adjacent to the dipping station and configured to direct the laminar flow directly over the dipping station.

Clause 5. The system of clause 4, wherein the laminar flow is in a direction vertically downward relative to ground.

Clause 6. The system of clause 4, wherein the laminar flow is in a direction horizontal relative to ground.

Clause 7. The system of any of clauses 1-6, wherein the first size of the first apertures is larger than the second size of the second apertures.

Clause 8. The system of any of clauses 1-7, wherein the controller is configured to activate the laminar flow only during the withdrawal of the working wire from the dipping solution.

Clause 9. The system of any of clauses 1-8, further comprising a robot configured to move the working wire into and out of the dipping solution at the dipping station; wherein the baffle is coupled to the robot.

Clause 10. The system of any of clauses 1-9, further comprising an air flow meter positioned to measure an air flow rate of the laminar flow from the baffle, wherein the controller is in communication with the air flow meter.

Clause 11. The system of any of clauses 1-10, wherein the dipping station includes a container having a lid; wherein the controller is configured to move the lid between a closed position and an open position, the lid being in the closed position when the dipping station is not in use.

Clause 12. The system of any of clauses 1-11, wherein the system further comprises a fluid reservoir in fluid communication with a plurality of holes in a bottom surface of a container at the dipping station, the container configured to hold the dipping solution.

Clause 13. The system of any of clauses 1-12, further comprising a mixing valve between a gas source and the baffle, wherein the mixing valve is configured to mix ambient air and a gas from the gas source.

Clause 14. The system of any of clauses 1-13, further comprising a gas source configured to supply a gas with predetermined relative humidity.

Clause 15. The system of any of clauses 1-14, further comprising: an optical measurement tool in the chamber, the optical measurement tool configured to measure a diameter of the working wire in a wire-holding fixture; and a robot in the chamber, the robot positioned to move the wire-holding fixture between the optical measurement tool and the dipping station; wherein the controller is in communication with the optical measurement tool and the robot and is configured to control a dipping parameter based on the diameter measured by the optical measurement tool.

Clause 16. The system of clause 15, wherein the robot is further configured to move the wire-holding fixture into and out of the dipping solution at the dipping station, and the dipping parameter comprises a withdrawal speed of the working wire from the dipping solution.

Clause 17. A method of coating a working wire a metabolic sensor, the method comprising: providing a dipping station in a chamber; providing a baffle configured to produce laminar flow over the dipping station; and providing a controller configured to activate the laminar flow during a dipping cycle at the dipping station, the dipping cycle including an insertion of the working wire into a dipping solution and a withdrawal of the working wire from the dipping solution. The baffle comprises a first plate having first apertures of a first size and a second plate having second apertures of a second size; and the first plate is positioned over the second plate, with the second plate toward the dipping station.

Clause 18. The method of clause 17, wherein the metabolic sensor is a continuous glucose monitor.

Clause 19. The method of any of clauses 17-18, wherein the baffle is coupled to a ceiling of the chamber.

Clause 20. The method of any of clauses 17-19, wherein the baffle is positioned adjacent to the dipping station and configured to direct the laminar flow directly over the dipping station.

Clause 21. The method of clause 20, wherein the laminar flow is in a direction vertically downward relative to ground.

Clause 22. The method of clause 20, wherein the laminar flow is in a direction horizontal relative to ground.

Clause 23. The method of any of clauses 17-22, wherein the first size of the first apertures is larger than the second size of the second apertures.

Clause 24. The method of any of clauses 17-23, wherein the controller is configured to activate the laminar flow only during the withdrawal of dipping the working wire from the dipping solution.

Clause 25. The method of any of clauses 17-24, further comprising providing a robot configured to move the working wire into and out of the dipping solution at the dipping station; wherein the baffle is coupled to the robot.

Clause 26. The method of any of clauses 17-25, further comprising controlling, by the controller, the laminar flow based on an air flow rate measured by an air flow meter.

Clause 27. The method of any of clauses 17-26, wherein the dipping station includes a container having a lid; wherein the controller is configured to move the lid between a closed position and an open position, the lid being in the closed position when the dipping station is not in use.

Clause 28. The method of any of clauses 17-27, further comprising providing a fluid reservoir in fluid communication with a plurality of holes in a bottom surface of a container at the dipping station, the container configured to hold the dipping solution.

Clause 29. The method of any of clauses 17-28, further comprising: measuring, by an optical measurement tool in the chamber, a diameter of the working wire in a wire-holding fixture; moving, by a robot in the chamber, the wire-holding fixture between the optical measurement tool and the dipping station; and controlling, by the controller in communication with the optical measurement tool and the robot, a dipping parameter based on the diameter measured by the optical measurement tool.

Clause 30. A system for coating a working wire a metabolic sensor, comprising: a dipping container shaped as a vertical longitudinal container, the dipping container having an entry port at a bottom end and an exit port at a top end, and configured to hold a dipping solution; a continuous feed wire source positioned to feed the working wire into the entry port; and an optical measurement tool configured to measure a diameter of the working wire after exiting the exit port.

Clause 31. The system of clause 30, further comprising: a baffle configured to produce laminar flow over the exit port of the dipping container; and a controller configured to activate the laminar flow while the working wire is exiting the exit port; wherein the baffle comprises a first plate having first apertures of a first size and a second plate having second apertures of a second size; wherein the first plate is positioned over the second plate, with the second plate toward the dipping container.

Clause 32. The system of clause 31, wherein the first size of the first apertures is larger than the second size of the second apertures.

Clause 33. The system of any of clauses 30-32, further comprising a die between the optical measurement tool and the exit port, the die having a hole through which the working wire is passed.

Clause 34. The system of any of clauses 30-33, further comprising a controller configured to control a speed of the working wire through the dipping container.

Clause 35. The system of any of clauses 30-34, further comprising a plurality of pulleys positioned to form a closed-loop path for the working wire between the exit port and the entry port of the dipping container.

Clause 36. The system of any of clauses 30-35, wherein the continuous feed wire source is a spool.

In some cases, a single example may, for succinctness and/or to assist in understanding the scope of the disclosure, combine multiple features. It is to be understood that in such a case, these multiple features may be provided separately (in separate examples), or in any other suitable combination. Alternatively, where separate features are described in separate examples, these separate features may be combined into a single example unless otherwise stated or implied. This also applies to the claims which can be recombined in any combination. That is, a claim may be amended to include a feature defined in any other claim. Furthermore, a phrase referring to “at least one of” a list of items refers to any combination of those items, including single members. As an example, “at least one of: a, b, or c” is intended to cover: a, b, c, a-b, a-c, b-c, and a-b-c.

Reference has been made in detail to aspects of the disclosed invention, one or more examples of which have been illustrated in the accompanying figures. Each example has been provided by way of explanation of the present technology, not as a limitation of the present technology. In fact, while the specification has been described in detail with respect to specific aspects of the invention, it will be appreciated that those skilled in the art, upon attaining an understanding of the foregoing, may readily conceive of alterations to, variations of, and equivalents to these aspects. For instance, features illustrated or described as part of one aspect may be used with another aspect to yield a still further aspect. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A system for coating a working wire of a metabolic sensor, comprising:
a chamber;
a dipping station in the chamber;
a baffle configured to produce laminar flow over the dipping station; and
a controller configured to activate the laminar flow during a dipping cycle at the dipping station, the dipping cycle including an insertion of the working wire into a dipping solution and a withdrawal of the working wire from the dipping solution;
wherein the baffle comprises a first plate having first apertures of a first size and a second plate having second apertures of a second size;
wherein the first plate is positioned over the second plate, with the second plate toward the dipping station.

2. The system of claim 1, wherein the metabolic sensor is a continuous glucose monitor.

3. The system of claim 1, wherein the baffle is coupled to a ceiling of the chamber.

4. The system of claim 1, wherein the baffle is positioned adjacent to the dipping station and configured to direct the laminar flow directly over the dipping station.

5. The system of claim 4, wherein the laminar flow is in a direction vertically downward relative to ground.

6. The system of claim 4, wherein the laminar flow is in a direction horizontal relative to ground.

7. The system of claim 1, wherein the first size of the first apertures is larger than the second size of the second apertures.

8. The system of claim 1, wherein the controller is configured to activate the laminar flow only during the withdrawal of the working wire from the dipping solution.

9. The system of claim 1, further comprising a robot configured to move the working wire into and out of the dipping solution at the dipping station;
wherein the baffle is coupled to the robot.

10. The system of claim 1, further comprising an air flow meter positioned to measure an air flow rate of the laminar flow from the baffle, wherein the controller is in communication with the air flow meter.

11. The system of claim 1, wherein the dipping station includes a container having a lid;
wherein the controller is configured to move the lid between a closed position and an open position, the lid being in the closed position when the dipping station is not in use.

12. The system of claim 1, wherein the system further comprises a fluid reservoir in fluid communication with a plurality of holes in a bottom surface of a container at the dipping station, the container configured to hold the dipping solution.

13. The system of claim 1, further comprising a mixing valve between a gas source and the baffle, wherein the mixing valve is configured to mix ambient air and a gas from the gas source.

14. The system of claim 1, further comprising a gas source configured to supply a gas with predetermined relative humidity.

15. The system of claim 1, further comprising:
an optical measurement tool in the chamber, the optical measurement tool configured to measure a diameter of the working wire in a wire-holding fixture; and
a robot in the chamber, the robot positioned to move the wire-holding fixture between the optical measurement tool and the dipping station;
wherein the controller is in communication with the optical measurement tool and the robot and is configured to control a dipping parameter based on the diameter measured by the optical measurement tool.

16. The system of claim 15, wherein the robot is further configured to move the wire-holding fixture into and out of the dipping solution at the dipping station, and the dipping parameter comprises a withdrawal speed of the working wire from the dipping solution.
